(19) United States
(12) Patent Application Publication
(10) Pub. No.: US 2002/0036736 A1
(43) Pub. Date: Mar. 28, 2002

(54) Liquid crystal display and method of manufacturing the same

(75) Inventors: Yutaka Nakai, Kanagawa-ken (JP); Yukio Kizaki, Kanagawa-ken (JP); Shintaro Enomoto, Kanagawa-ken (JP); Masao Tanaka, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Toshiba, Minato-ku (JP)

(21) Appl. No.: 09/960,489

(22) Filed: Sep. 24, 2001

(30) Foreign Application Priority Data
Sep. 27, 2000 (JP) 2000-293622

(51) Int. Cl. G02F 1/1333

(52) U.S. Cl. 349/122

(57) ABSTRACT

A liquid crystal display, and a method of manufacturing the same, the display including a substrate; a pixel electrode on the substrate; a pixel isolator surrounding the pixel electrode, the pixel isolator being formed by an insulator. The display also includes a liquid crystal layer on the pixel electrode surrounded by the pixel isolator; a common electrode on the liquid crystal layer; and a counter substrate on the common electrode.

### CROSS-REFERENCE TO RELATED APPLICATIONS

This application is based upon and claims the benefit of priority from Japanese Patent Application No. P2000-293622, filed on Sep. 27, 2000; the entire content of which is hereby incorporated herein by reference.

### BACKGROUND OF THE INVENTION

1. Field of the Invention

The present invention relates to a liquid crystal display and a method of manufacturing the same.

2. Discussion of the Background

In recent years, there has been an intense development of new displays intended to replace conventional CRT. Among the new displays, liquid crystal displays are anxiously expected in the markets of household electrical appliances and Office Automation (OA) apparatus because these displays are thin and can be operated at low power.

There are at least two types of liquid crystal displays: a transmission type liquid crystal display that includes a planer type illumination, referred to as backlight, at a back face of a liquid crystal panel; and a reflection type liquid crystal display that includes a reflecting plate for reflecting light at a back face of the liquid crystal panel for displaying by reflecting outside light to a display face. These liquid crystal displays are not only used for a monochromatic display but also for a colored liquid crystal display.

As a method of realizing a colored liquid crystal display, there is an electrically controlled birefringence (ECB) system in which wavelength of transmitted or reflected light differs with applied voltage. This system, however, poses the problem of displaying a narrow color range. There also is a system of planely arranging color filters of red, green and blue and using liquid crystal as an optical shutter in order to promote color reproducing performance. However, according to this system, three primary color portions must be provided for one pixel since the system is constituted by additive color mixture. Accordingly, only a third area can be displayed and there poses a problem that a display screen is darkened.

There exists also a method of using subtractive color mixture by a structure laminated with three layers of cyan, magenta and yellow in a thickness direction as liquid crystal layers in order to promote light utilizing efficiency (see, for example, Japanese Patent Laid-Open No. 337643/1994 or Japanese Patent Laid-Open No. 313939/1996, the entire contents of which are hereby incorporated herein by reference). According to this method, a voltage is applied to the liquid crystal layers of respective pixel independently from each other to carry out a display.

In Japanese Patent Laid-Open No. 313939/1996, an explanation is given to a liquid crystal display shown in FIG. 10. Liquid crystal microcapsule layers 94a, 94b and 94c are laminated above a glass substrate 91. Respective electrodes 95 and 96 are installed among the liquid crystal microcapsule layers. Thin Film Transistors (TFTs) 92 are installed to respective pixels and connected to the respective electrodes 95 and 96 via copper-plated columns 93.

In this device, voltage can be applied to the liquid crystal microcapsule layers 94a, 94b and 94c of respective colors independently from each other. However, lengths of the copper-plated columns 93 for connecting the respective electrodes 95 and 96 and TFTs 92 differ from each other and therefore, the number of manufacturing steps becomes relatively large.

That is, according to this example, formation of the liquid crystal microcapsule layers 94a, 94b and 94c of respective colors, patterning the layers, formation of the copper-plated columns 93 and formation of the respective electrodes 95, 96 and 97 are repeatedly carried out. Therefore, the number of steps is large and the structure is relatively complicated. Accordingly, not only is the cost increased, but a reduction in yield is difficult to avoid.

In order to increase the aperture rate, one needs to increase the accuracy of positioning the reflective electrode 95 and the two layers of the transparent electrodes 96. However, since the patterning accuracy of a printing step is poor, it is technically difficult to increase the accuracy of matching the electrodes.

When color display is carried out in a liquid crystal display, there exists a system of planely arranging Red, Green, Blue (RGB) color filters and using liquid crystal as an optical shutter. However, since the system is constituted by additive color mixture, three primary colors can be displayed only over one third of the display area. Therefore, there poses a problem that the efficiency of utilizing light is deteriorated and a display screen is darkened.

Furthermore, there also exists a system of using subtractive color mixture by a structure of laminating three layers of cyan, magenta and yellow as liquid crystal layers. However, according to this system, electrodes for driving liquid crystals must be installed for the respective layers. It is preferred to form a plurality of connecting portions having different heights for connecting the electrodes and TFTs. Further, the electrodes for applying a voltage to the liquid crystal layers are formed by a plurality of printing steps and therefore, patterning accuracy of the printing steps is low. Accordingly, the laminated structure is not formed accurately, and there is a deterioration in the aperture ratio, an increase in cost owing to the complicated steps and a reduction in yield in these systems.

### SUMMARY OF THE INVENTION

In a first embodiment, the present invention provides a liquid crystal display including: a substrate; a pixel electrode on the substrate; a pixel isolator surrounding the pixel electrode, the pixel isolator being formed by an insulator. The display also includes a liquid crystal layer on the pixel electrode surrounded by the pixel isolator; a common electrode on the liquid crystal layer; and a counter substrate on the common electrode.

In another embodiment, the present invention provides a liquid crystal display including: a substrate, a pixel electrode on the substrate; a pixel isolator surrounding the pixel electrode, the pixel isolator being formed by an insulator. The display also includes a first connection electrode on the substrate and insulated from the pixel electrode; a second connection electrode on the substrate and insulated from the pixel electrode and the first connection electrode. A first liquid crystal layer is placed on the pixel electrode and is surrounded by the pixel isolator. A first transparent electrode on the first liquid crystal layer and surrounded by the pixel isolator is electrically connected to the first connection electrode. A second liquid crystal layer is placed on the first transparent electrode and surrounded by the pixel isolator. A second transparent electrode on the second liquid crystal layer and surrounded by the pixel isolator is electrically connected to the second connection electrode. A third liquid crystal layer is placed on the second transparent electrode. The display also includes a common electrode on the third liquid crystal layer; and a counter substrate on the common electrode.

The present invention may further include: a pixel switch element connected to the pixel electrode; a first switch element connected to the first connection electrode; and a second switch element connected to the second connection electrode.

The present invention may further include: a first conductor column provided between the first connection electrode and the first transparent electrode; and a second conductor column provided between the second connection electrode and the second transparent electrode.

The present invention may further include: a conductor connecting between the first connection electrode and the first transparent electrode or connecting between the second connection electrode and the second transparent electrode, the conductor being provided on the pixel isolator.

In yet another embodiment, the present invention provides a liquid crystal display including: a substrate; a pixel electrode on the substrate; a first connection electrode on the substrate and insulated from the pixel electrode; a second connection electrode on the substrate and insulated from the pixel electrode and the first connection electrode. The display also includes a first pixel isolator surrounding the pixel electrode, the first pixel isolator being formed by an insulator. A first liquid crystal layer is placed on the pixel electrode and is surrounded by the first pixel isolator. A first transparent electrode on the first liquid crystal layer and surrounded by the first pixel isolator is electrically connected to the first connection electrode. The device also includes a second pixel isolator formed on the first pixel isolator. A second liquid crystal layer is placed on the first transparent electrode and surrounded by the second pixel isolator. A second transparent electrode on the second liquid crystal layer and surrounded by the second pixel isolator is electrically connected to the second connection electrode. A third liquid crystal layer is placed on the second transparent electrode. The display also includes a common electrode on the third liquid crystal layer; and a counter substrate on the common electrode.

The present invention may further include: a first conductor connecting between the first connection electrode and the first transparent electrode, the first conductor being provided on the first pixel isolator; a second conductor connecting between the second connection electrode and the second transparent electrode, the second conductor being provided on the second pixel isolator.

The present invention may further include: a first conductor connecting between the first connection electrode and the first transparent electrode, the first conductor being provided -on the first pixel isolator; an insulator provided between the first pixel isolator and the second pixel isolator; and a second conductor connecting between the second connection electrode and the second transparent electrode, the second conductor provided on the insulator.

In another embodiment, the present invention provides a liquid crystal display including: a substrate; a pixel electrode on the substrate; a pixel isolator isolating the pixel electrode; a first connection electrode on the substrate and insulated from the pixel electrode; and a second connection electrode on the substrate and insulated from the pixel electrode and the first connection electrode. A first liquid crystal layer is placed on the pixel electrode and isolated by the pixel isolator. A first transparent electrode on the first liquid crystal layer and isolated by the pixel isolator, is electrically connected to the first connection electrode. A second liquid crystal layer is placed on the first transparent electrode and is isolated by the pixel isolator. A second transparent electrode on the second liquid crystal layer and isolated by the pixel isolator, is electrically connected to the second connection electrode. A third liquid crystal layer is placed on the second transparent electrode. The display also includes a common electrode on the third liquid crystal layer; and a counter substrate on the common electrode.

The present invention may further include: a conductor connecting between the first connection electrode and the first transparent electrode or connecting between the second connection electrode and the second transparent electrode, the conductor touching the pixel isolator.

In another embodiment, the present invention provides a liquid crystal display including: a substrate; a pixel electrode on the substrate; a pixel isolating means for isolating pixels from each other. A first liquid crystal layer is placed on the pixel electrode and isolated by the pixel isolating means. A first transparent electrode is placed on the first liquid crystal layer and is isolated by the pixel isolating means. A second liquid crystal layer is placed on the first transparent electrode and is isolated by the pixel isolating means. A second transparent electrode is placed on the second liquid crystal layer and isolated by the pixel isolating means. A third liquid crystal layer is placed on the second transparent electrode. The display also includes a common electrode on the third liquid crystal layer; and a counter substrate on the common electrode.

The present invention also provides a method for manufacturing a liquid crystal display including the steps of: forming a pixel electrode, a first connection electrode and a second connection electrode on a substrate, insulated from each other; forming a pixel isolator surrounding the pixel electrode; forming a first liquid crystal layer in the pixel isolator and on the substrate; forming a first transparent electrode on the first liquid crystal layer, the first transparent electrode being connected to the first connection electrode; forming a second liquid crystal layer on the first transparent electrode; and forming a second transparent electrode on the second liquid crystal layer, the second transparent electrode connected to the second connecting electrode.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a sectional view illustrating a first embodiment of the invention;

FIGS. 2A, 2B and 2C are sectional views illustrating a method of manufacturing a liquid crystal display according to a first embodiment of the invention;

FIG. 3 is a plane view of FIG. 2A;

FIG. 4 is a sectional view illustrating a second embodiment of the present invention;

FIG. 5 is a sectional view illustrating a third embodiment of the present invention;

FIG. 6 is a sectional view illustrating a fourth embodiment of the present invention;

FIGS. 7A, 7B and 7C are sectional views illustrating a method of manufacturing a liquid crystal display according to a fifth embodiment of the present invention;

FIG. 8 is a sectional view illustrating a sixth embodiment according to the present invention;

FIG. 9 is a sectional view illustrating a modified example of the sixth embodiment; and

FIG. 10 is a sectional view showing a conventional liquid crystal display.

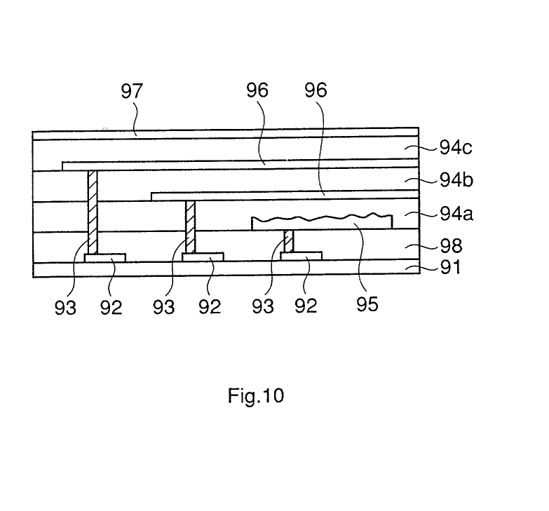

### DETAILED DESCRIPTION OF THE EMBODIMENTS

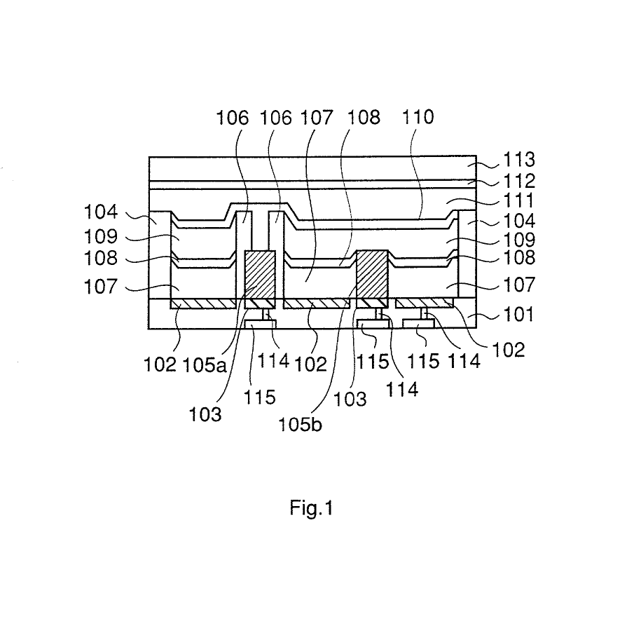

Referring now to the drawings wherein like reference numerals designate identical or corresponding parts throughout the several views and more particularly to FIG. 1 thereof, there is illustrated a pixel of the liquid crystal display according to a first embodiment of the present invention.

As shown by FIG. 1, a pixel isolator 104 is provided to surround a pixel above a substrate 101. An insulating, material is used-for the pixel isolator 104. A common electrode 112 is provided on a counter substrate 113. Within the one pixel, a pixel electrode 102 and connection electrodes 103 are formed above the substrate 101. A conductor column 105a and a conductor column 105b are provided at the connection electrodes 103. The connection electrode 103 is insulated from the pixel electrode 102. That is, the connection electrode 103 is provided at a portion constituted by mortising a portion of the pixel electrode 102.

The conductor column 105b is electrically connected to a first transparent electrode layer 108. Further, the conductor column 105a is electrically connected to a second transparent electrode layer 110. The conductor column 105a is surrounded by an insulator 106 for insulating from the first transparent electrode layer 108.

A first liquid crystal microcapsule layer 107 is provided between the pixel electrode 102 and the first transparent electrode layer 108. A second liquid crystal microcapsule layer 109 is provided between the first transparent electrode layer 108 and the second transparent electrode layer 110. Further, a third liquid crystal microcapsule layer 111 is provided between the second transparent electrode layer 110 and the common electrode 112.

The pixel electrode 102, the first transparent electrode 108 and the second transparent electrode 110 are respectively connected with switch elements 115 via connecting portions 114. In this case, the switch element 115 is provided with a switch function. Further, although not illustrated here, the switch element 115 is connected to a signal line and a scanning line.

With such a pixel structure, a voltage can be applied to the pixel electrode 102, the first transparent electrode 108, the second transparent electrode 110 and the common electrode 112 independently from each other. Therefore,-respectively different voltage can be applied to the first liquid crystal microcapsule layer 107, the second liquid crystal microcapsule layer 109, and the third liquid crystal microcapsule layer 111.

According to the embodiment, the first transparent electrode 108, the second transparent electrode 110, the first liquid crystal microcapsule layer 107, and the second microcapsule layer 109 are surrounded by the pixel isolator 104 for respective pixel and accordingly, completely isolated from other pixel.

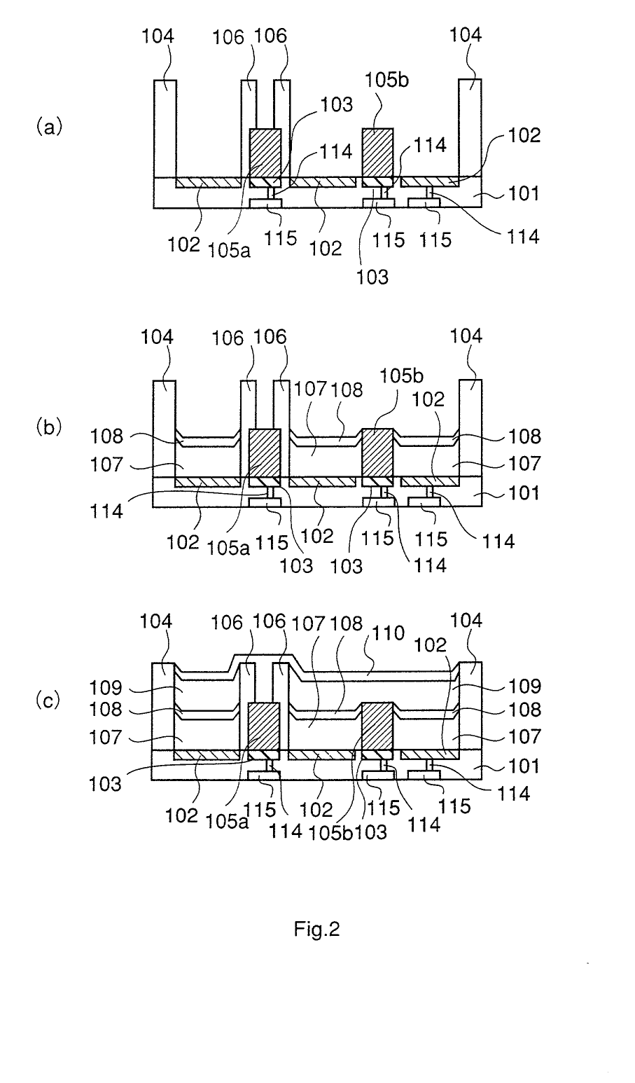

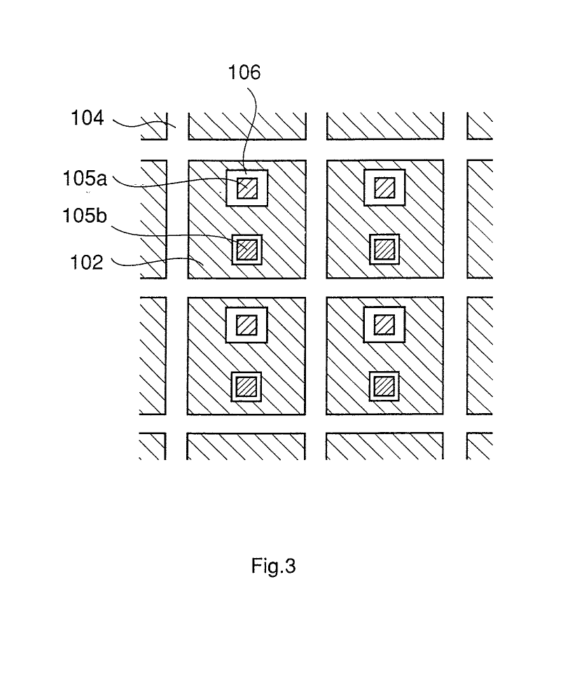

An explanation is now given of a method of manufacturing the liquid crystal display according to this embodiment. FIGS. 2A, 2B and 2C are partial sectional views for explaining the manufacturing method according to the embodiment and FIG. 3 is a plane view of FIG. 2A.

First, as shown by FIG. 2A and FIG. 3, the pixel electrode 102 and the connection electrodes 103 of two per pixel are formed above the substrate 101 having insulating properties. The pixel electrode 102 and the connection electrodes 103 are formed, for example, by using aluminum, silver or an alloy having these as main components. These electrodes may be formed by the same material or may use different materials. The pixel electrode 102 and the connection electrodes 103 are connected to the switch elements 115 arranged at the substrate 101 via the connecting portions 114.

The pixel electrode 102 and the connection electrodes 103 are connected to the switch elements 115 provided, for example, at the back face of the substrate 101. The figures illustrate the case in which the switch elements 115 are formed at the back face of the substrate 101. However, the switch elements 115 can be provided between the substrate 101 and the pixel electrode 102.

Next, the columns of conductors 105a and 105b having a height of about 10 μm are formed above the connection electrodes 103 by a plating step by using a material of copper, nickel or the like. The columns of conductors 105a and 105b may be made of the same material or different materials.

The insulator 106 is formed so as to surround the conductor column 105a and the pixel isolator 104 surrounding the pixel. For example, the insulator 106 and the pixel isolator 104 can be formed to have a height of about 20 μm by using a material such as a photosensitive resist. The thicknesses of the insulator 106 and the pixel isolator 104 can be about 8 μm. The insulator 106 and the pixel isolator 104 are provided to make the conductor 105a electrically independent. As shown in FIG. 3, the pixel isolator 104 isolates the respective pixel electrically and physically. That is, the pixel isolator 104 is provided between pixels for isolating the pixels. However, when the isolator 106 and the pixel isolator 104 are thickened, the aperture ratio is deteriorated and accordingly, it is preferred to balance the thicknesses of the insulator 106 and the pixel isolator 104 and the aperture ratio.

Next, the liquid crystal layer is formed. An explanation is now given of an example of using a liquid crystal microcapsule. A liquid crystal microcapsule involves guest host liquid crystals dissolving dichroic dyes in the liquid crystals in a capsule made of resin. The first liquid crystal microcapsule layer 107 is set to cyan, the second microcapsule layer 109 is set to yellow and the third microcapsule layer 111 is set to magenta.

An explanation is now given of a method of forming a liquid crystal microcapsule using cyan as an example. First, there are mixed and dissolved about 80 weight portions of nematic liquid crystals (made by Chisso K.K. Lixon5065xx) having positive dielectric anisotropy, about 2 weight portions of cyan dye (made by Mitsui Kagaku K.K. SI-497), about 7 weight portions of capsule wall material (hydrophilic methylmethacrylate monomer), about 7 weight portions of hydrophobic isobutylmethacrylate, about 1 weight portion of a cross linking agent (ethylene glycol dimethacrylate) and about 0.2 weight portion of a polymerization initiator (benzoyl peroxide (BPO)).

By using a film emulsifier made by Ise Kagaku K.K., the mixture solution is extruded into a flow of an aqueous solution of about 0.3 weight percent of polyvinyl alcohol through a porous glass tube having a mean pore diameter of about 1.4 μm. An emulsion having a mean particle size of about 7 μm is thus prepared. The emulsion is polymerized at about 85° C. for about 1 hour.

After the polymerization, the emulsion is filtrated by a filter having a pore diameter of about 1 μm and cleaned by pure water by about 3 times. The liquid crystal microcapsule of cyan with a transparent polymer film is thus provided. The average particle diameter of the liquid crystal microcapsule is about 7 μm.

When the liquid crystal microcapsule of magenta is formed, about 2 weight portions of magenta dye (made by Nippon Kankosei Shikiso K.K. G-176) may be used in place of cyan dye. When the liquid crystal microcapsule of yellow is formed, about 2 weight portions of yellow dye (made by Mitsubishi Kagaku K.K. LSY-310) may be used in place of the cyan dye.

The liquid crystal microcapsules prepared in this way are dispersed in a solvent to constitute about 30 weight %. A solvent dissolved with about 10 weight % of isopropyl alcohol and about 4 weight % of hydroxyethyl cellulose in water can be used.

The liquid crystal microcapsule of cyan is dripped onto the pixel electrode 102 and baked. The first liquid crystal microcapsule layer 107 having a thickness of about 8 μm is thus formed. During this step, as shown by FIG. 2B, the liquid crystal microcapsule of cyan is dripped to avoid an inner side of the insulator 106 and the conductor column 105b which have previously been formed. An upper portion of the conductor column 105b is kept exposed. A method of dripping the liquid crystal microcapsule may be carried out by an ink jet method other than screen printing and is not particularly limited.

Next, the first transparent electrode layer 108 is formed above the first liquid crystal microcapsule layer 107. In this case, water dispersion with small particles of Indium Tin Oxide (ITO) is coated above the first liquid crystal microcapsule layer 107. When the first transparent electrode 108 is formed, as shown by FIG. 2B, the inner side of the insulator 106 formed previously is avoided, i.e., not coated with the water dispersion. However, the water is coated above the conductor column 105b to thereby electrically connect the conductor column 105b and the first transparent electrode 108.

The liquid crystal microcapsule of yellow is dripped above the first transparent electrode 108 and is baked. The second liquid crystal microcapsule layer 109 having a thickness of about 10 μm is thus formed. During this step, as shown by FIG. 2C, the liquid crystal microcapsule can be dripped to avoid the inner side of the insulator 106 previously formed.

The second transparent electrode layer 110 is then formed above the second liquid crystal microcapsule layer 109 by using a material and a method similar to those of the first transparent electrode layer 108. During this step, the second transparent electrode layer 110 is formed to spread over the entire pixel including the inner side of the insulator 106 previously formed. That is, the second transparent electrode layer 110 is electrically connected to the upper portion of the conductor 105a.

Next, the liquid crystal microcapsule of magenta is dripped and baked. The third liquid crystal microcapsule layer 111 is thus formed. During this step, the third liquid crystal microcapsule layer 111 is formed not just for respective pixels but over an entire face uniformly. Thereafter, the counter substrate 113 is formed with the counter electrode 112, which is pasted together with the third liquid crystal microcapsule layer 111. Based on the above method, the liquid crystal display element shown by FIG. 1 can be formed.

Thereafter, the liquid crystal display element is connected to a peripheral circuit (not illustrated) to thereby finish the liquid crystal display according to the embodiment.

According to the liquid crystal display of the embodiment, each pixel is partitioned by the pixel isolator 104, so that each pixel is independent from a contiguous (adjacent) pixel. That is, the pixel electrode 102, the first transparent electrode 108 and the second transparent electrode 110 are completely isolated from the contiguous pixels by the pixel isolator 104. The first liquid crystal microcapsule layer 107 and the second liquid crystal microcapsule layer 109 sandwiched are also isolated from the contiguous pixel. Therefore, desired voltages can be applied to each pixel without being influenced by a signal applied to the contiguous pixel.

The pixel is partitioned previously by the pixel isolator 104 and therefore, even when three colors of the liquid crystal microcapsule layers are formed, there is no need to accurately position the coating processes. The accuracy of coating is thus remarkably improved in each pixel, so that a liquid crystal display having high aperture ratio can easily be realized. Further, nonuniformity of color caused by positional shift can be prevented.

According to the embodiment, the pixel isolator 104 and the insulator 106 can be formed by a photosensitive resist. When the pixel isolator 104 and the insulator 106 are formed by resin, surface treatment of the resin is facilitated. For example, by forming the pixel isolator 104 and the insulator 106 and thereafter subjecting these isolators to fluorine plasma processing, water repellency of surfaces of these isolators can selectively be increased. By increasing the water repellency, meniscuses formed at interfaces between the liquid crystal microcapsule layers and the respective transparent electrode layers, and surface of the resin can be restrained.

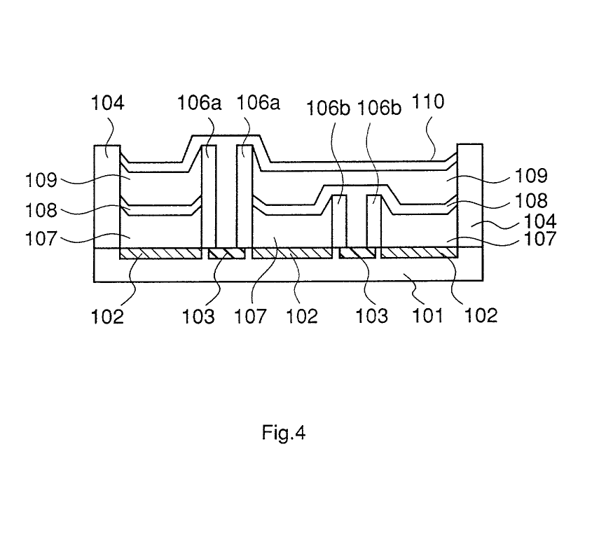

Another embodiment is now described in relation to FIG. 4, wherein conductor columns are not used. As in the first embodiment, the pixel electrode 102 and the connection electrodes 103 are arranged above the substrate 101. The switch elements and wirings are provided above the substrate 101, although the illustration thereof is omitted. Each pixel is partitioned by the pixel isolator 104. A long insulator 106a and a short insulator 106b are provided above the connection electrodes 103 in the pixel. For example, the long insulator 106a is provided with a height of about 20 μm and the short insulator 106b is provided with a height of about 10 μm.

As in the first embodiment, the first transparent electrode 108 and the second transparent electrode 110 are formed. However, when the first transparent electrode 108 is formed, the inside of the short insulator 106b is filled with the material of the transparent electrode 108. Accordingly, the connection electrode 103 and the first transparent electrode 108 are electrically connected. When the second transparent electrode 110 is formed, the inside of the long insulator 106a is filled with the material of the transparent electrode 110. Accordingly, the connection electrode 103 and the second transparent electrode 108 are electrically connected.

The other portions are formed similarly to those of the first embodiment. Also according to this embodiment, there can be realized subtractive color mixture having a high light utilizing efficiency by the structure laminated with three layers of the liquid crystal layers in the thickness direction.

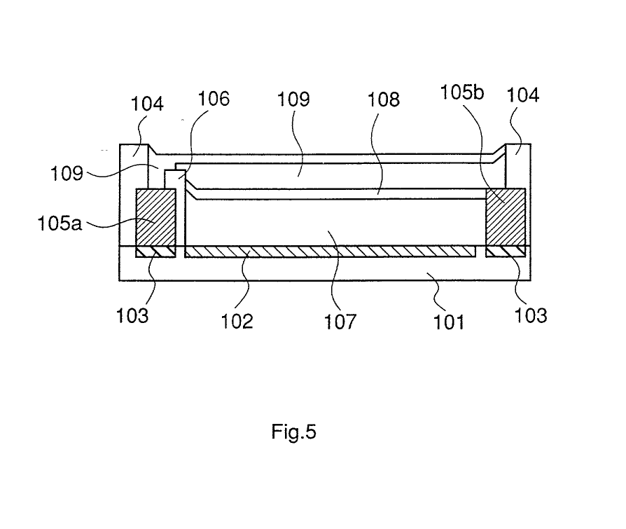

Next, a third embodiment is described in relation to FIG. 5, wherein the positions of the conductor columns 105a and 105b differ from those of the first embodiment.

According to this embodiment, as in the first embodiment, the pixel electrode 102 and the connection electrodes 103 are provided above the substrate 101. However, the connection electrodes 103 are disposed at end portions of the pixel and provided at positions contiguous to the pixel isolator 104. Switch elements and wirings are provided above the substrate 101, although the illustration thereof is omitted. The respective pixel is partitioned by the pixel isolator 104. The insulator 106 is provided on the connection electrode 103 in the pixel. The height of the insulator 106 is lower than a height of the pixel isolator 104 and is a height of, for example, about 15 μm. The rest of the pixel may be formed similarly to that of the first embodiment.

According to this embodiment, positions of the conductor columns are arranged at the end portions of the pixel so that the aperture ratio of the pixel can be increased. When the liquid crystal microcapsule layers are formed, the liquid crystal microcapsules are easy to drip to avoid the pixel isolator 104 and the liquid crystal display can be manufactured with excellent yield.

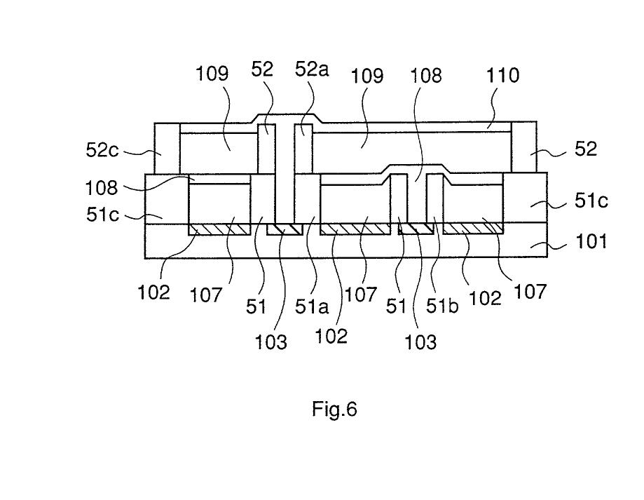

Next, a fourth embodiment is described in relation to FIG. 6, wherein the structure of an insulator differs from that in the first embodiment. According to this embodiment, as in the first embodiment, the pixel electrode 102 and the connection electrodes 103 are provided above the substrate 101.

A first pixel isolator 51c is formed to surround of a pixel and the first insulators 51a and 51b are formed on the connection electrodes 103. According to this embodiment, the first pixel isolator 51c and the first insulators 51a and 51b can be formed simultaneously by one step. Heights of the insulators 51a and 51b and the first pixel isolator 51c are set to, for example, about 10 μm.

After forming the first insulators 51, as in the first embodiment, the first liquid crystal microcapsule layer 107 is formed to avoid inner portions of the first insulators 51a and 51b.

The first transparent electrode 108 is formed above the first liquid crystal microcapsule. During this step, as in the second embodiment, the material of the transparent electrode 108 fills the inner portion of the first insulator 51b to thereby electrically connect to the connection electrode 103.

Thereafter, a second insulator 52a is formed above the first insulator 51a and a second pixel isolator 52c is formed above the first pixel isolator 51c. The second insulator 52a and the second pixel isolator 52c can simultaneously be formed. In this case, a height of combining the first insulator 51a and the second insulator 52a may be set to about 20 μm. Further, the thicknesses of the first insulator 51a and the first pixel isolator 51c are formed to be sufficiently thick so as to form the second insulator 52a and the second pixel isolator 52c thereabove. For example, the thicknesses may be about 14 μm. Thicknesses of the second insulator 52a and the second pixel isolator 52c may be, for example, about 8 μm. The rest of the pixel may be formed similarly to that of the first embodiment.

According to this embodiment, as in the first embodiment, the respective pixel is isolated and therefore, the pixel can be driven regardless of the voltage applied to a peripheral pixel. According to this embodiment, the steps of forming the insulators and the pixel isolator can be simplified.

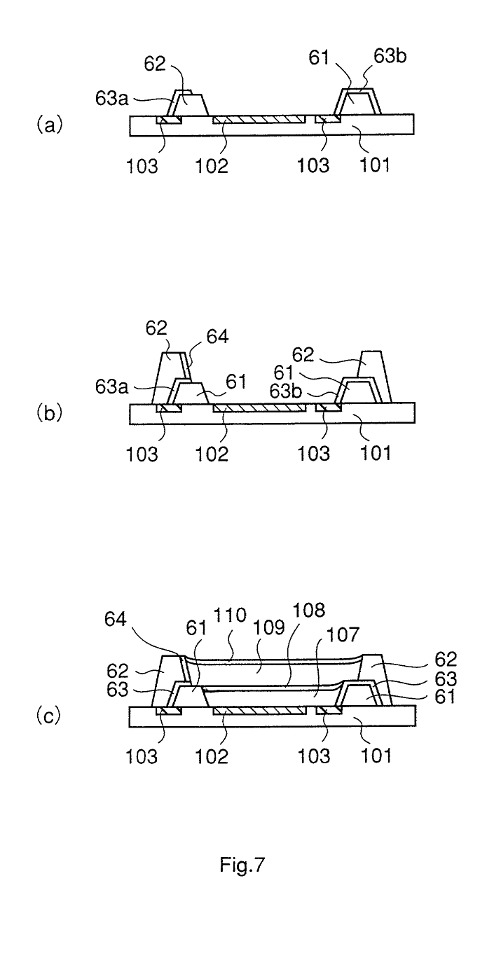

Next, a fifth embodiment is described in relation to FIGS. 7A, 7B and 7C. FIGS. 7A, 7B and 7C are partial sectional views showing a pixel. In explaining the embodiment, an explanation is given centering on a point different from that of the first embodiment. The pixel electrode 102 and the connection electrodes 103 are provided above the substrate 101. Switch elements and wirings connected to the pixel electrode 102 and the connection electrodes 103 are formed, although the illustration thereof is omitted.

As shown by FIG. 7A, a first insulator 61 is formed by using a photosensitive resist to surround a pixel. During this step, a height thereof is set to about 10 μm. One of the connection electrodes 103 is disposed on an inner side of the insulator 61 and the other of the connection electrodes 103 is disposed on an outer side of the insulator 61.

First conductors 63a and 63b are formed at vicinities of the connection electrodes 103 above the insulator 61. The first conductors 63a and 63b are formed with, for example, A1, ITO or the like over entire faces thereof by using a sputtering method or a vacuum film forming method. Thereafter, the first conductors 63a and 63b are made to remain only at vicinities of the connection electrodes 103 by coating a resist thereon and exposing and developing these. In this case, the first conductor 63a is formed only at an outer side portion of the pixel. The first conductor 63a is electrically connected to the connection electrode 103 on the outer side of the first insulator 61 and the first conductor 63b is electrically connected to the connection electrode 103 on the inner side of the first insulator 61.

Next, as shown by FIG. 7B, a second insulator 62 is formed by shifting a central portion thereof above the first insulator. In this case, the second insulator is formed to surround the pixel. A height of the second insulator 62 from the substrate 101 is, for example, about 20 μm.

A second conductor 64 is provided partially above the second insulator 62. The second conductor 64 is electrically connected to the first conductor 63a.

Next, there is formed the liquid crystal microcapsule layer 107 having a height the same as that of the first insulator 63. The thickness of the first liquid crystal microcapsule layer 107 is set to, for example, about 8 μm.

The first transparent electrode 108 is provided above the first liquid crystal microcapsule layer 107. During this step, the first transparent electrode 108 is electrically connected to the first conductor 63.

The second liquid crystal microcapsule layer 109 having the same height as that of the second insulator 62 above the first transparent electrode 108 is formed. The thickness of the second liquid crystal microcapsule layer 109 is set to, for example, about 8 μm.

The second transparent electrode 110 is formed above the second liquid crystal microcapsule layer 109. The second transparent electrode 110 is electrically connected to the second conductor 64. In this embodiment, the first transparent electrode and the second transparent electrode are respectively connected to the connection electrode 103.

Although an explanation has been given here of an example of forming the first liquid crystal microcapsule layer 107 after forming the second insulator 62, the first liquid crystal microcapsule layer 107 can also be formed before forming the second insulator 62. As in the first embodiment, the third liquid crystal microcapsule layer is formed above the second transparent electrode and the opposed substrate is arranged. The rest of the pixel may be formed similarly to that of the first embodiment.

In this embodiment, the liquid crystal display element can be formed without providing the conductor columns. As in the first embodiment, the pixel is surrounded by the insulators and the pixel can be driven without being influenced by voltages applied on contiguous pixels. According to this embodiment, the aperture ratio can be increased since the conductor columns are not provided.

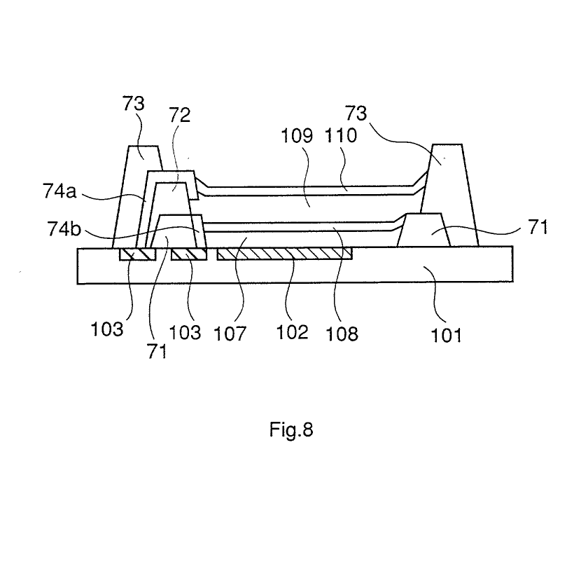

Next, a sixth embodiment is now in relation to FIG. 8, wherein as insulators surrounding a pixel, there are provided three layers of a first insulator 71, a second insulator 72 and a third insulator 73.

In FIG. 8, switch elements, wirings or the like provided on the substrate 101 are omitted. As in the fifth embodiment, the first insulator 71 is formed to surround the pixel. A height thereof is, for example, about 10 μm. In this case, the connection electrodes 103 are disposed on the inner side and the outer side of the first insulator 71.

Thereafter, there is formed a first conductor 74b connected with a portion of the first insulator 71 and the connection electrode 103 on the inner side. The first conductor 74b can be formed by forming the first conductor 74b over the entire face of the first insulator 71 and patterning the first conductor 74b. A conductor film may be formed after forming a coated film while leaving a portion of the first insulator 71 uncoated and an unnecessary portion of the conductor film may be removed along with the coated film.

Next, the second insulator 72 is formed above a portion of the first insulator 71. A height thereof from the substrate 101 is, for example, about 15 μm.

A second conductor 74a is formed above the second insulator 72 similar to the first conductor 74b. In this case, the second conductor 72a is insulated from the first conductor 72b.

Further, the third insulator 73 is formed to surround the pixel. A height thereof from the substrate 101 is, for example, about 20 μm.

As in the first embodiment, the first liquid crystal microcapsule layer 107 is formed by dripping the liquid crystal microcapsule. Further, the first transparent electrode 108 is formed and connected to the first conductor 74b.

The second liquid crystal microcapsule layer 109 and the second transparent electrode 110 are formed thereabove.

Although an explanation has been given here of a method of forming the liquid crystal microcapsule layer after forming the second insulator 72 and the third insulator 73, the first liquid crystal microcapsule layer 107 can also be formed after forming the first insulator 71. In this way, the order can pertinently be switched.

Thereafter, the liquid crystal display is formed by forming the third liquid crystal microcapsule layer over an entire face thereof and arranging the opposed substrate although illustration thereof is omitted.

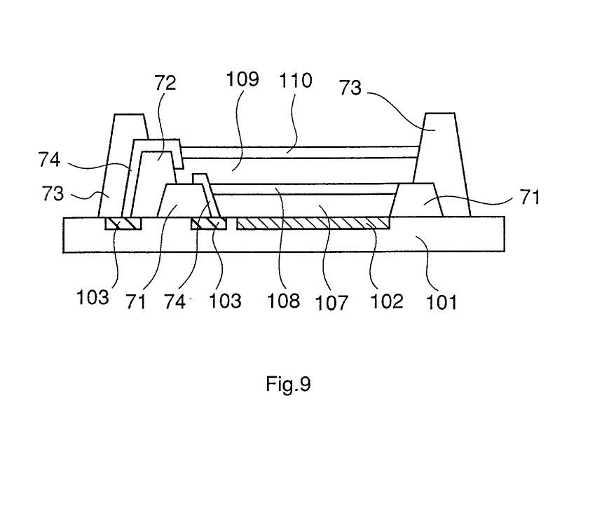

According to this embodiment, the liquid crystal display can be driven without being influenced by voltages applied on contiguous pixels. Three layers of the liquid crystal microcapsule layers can be coated with excellent accuracy. Positions of forming the respective insulators 71, 72 and 73 can be changed as shown by FIG. 9.

Although in explaining the above-described embodiments, an explanation has been given of the liquid crystal microcapsule layers using the liquid crystal microcapsules as the liquid crystal layers, the liquid crystal layers are not limited thereto. For example, nematic curvilinear aligned phase (NCAP) or polymer-dispersed liquid crystal (PDLC) and the like can be used. These are liquid crystal matrix composite materials including liquid crystals in solid members dispersedly supporting the liquid crystals.

As described above, a liquid crystal display can be formed with a high light utilizing efficiency, a simple structure and a high aperture rate.

Obviously, numerous modifications and variations of the present invention are possible in light of the above teachings. It is therefore to be understood that within the scope of the appended claims, the invention may be practiced otherwise than as specifically described herein.

What is claimed is:

1. A liquid crystal display comprising:
a substrate;
a pixel electrode on said substrate;
a pixel isolator surrounding said pixel electrode, said pixel isolator being formed by a insulator;
a liquid crystal layer on said pixel electrode surrounded by said pixel isolator;
a common electrode on said liquid crystal layer; and
a counter substrate on said common electrode.

2. A liquid crystal display comprising:
a substrate;
a pixel electrode on said substrate;
a pixel isolator surrounding said pixel electrode, said pixel isolator being formed by an insulator;
a first connection electrode on said substrate and insulated from said pixel electrode;
a second connection electrode on said substrate and insulated from said pixel electrode and said first connection electrode;
a first liquid crystal layer on said pixel electrode and surrounded by said pixel isolator;
a first transparent electrode on said first liquid crystal layer and surrounded by said pixel isolator, said first transparent electrode being electrically connected to said first connection electrode;
a second liquid crystal layer on said first transparent electrode and surrounded by said pixel isolator;
a second transparent electrode on said second liquid crystal layer and surrounded by said pixel isolator, said second transparent electrode being electrically connected to said second connection electrode;
a third liquid crystal layer on said second transparent electrode;
a common electrode on said third liquid crystal layer; and
a counter substrate on said common electrode.

3. A liquid crystal display according to claim 2,
wherein one of said first liquid crystal layer, said second liquid crystal layer and said third liquid crystal layer comprises liquid crystal microcapsules.

4. A liquid crystal display according to claim 2,
wherein one of said first liquid crystal layer, said second liquid crystal layer and said third liquid crystal layer comprises liquid crystal suspended in a solid layer.

5. A liquid crystal display according to claim 2, further comprising:
a pixel switch element connected to said pixel electrode;
a first switch element connected to said first connection electrode; and
a second switch element connected to said second connection electrode.

6. A liquid crystal display according to claim 2, further comprising:
a first conductor column provided between said first connection electrode and said first transparent electrode;
a second conductor column provided between said second connection electrode and said second transparent electrode.

7. A liquid crystal display according to claim 6,
wherein one of said first conductor column and said second conductor column touches said pixel isolator.

8. A liquid crystal display according to claim 2,
wherein said pixel isolator has a tapered cross section.

9. A liquid crystal display according to claim 8, further comprising:
a conductor connecting between said first connection electrode and said first transparent electrode or connecting between said second connection electrode and said second transparent electrode, said conductor being provided on said pixel isolator.

10. A liquid crystal display according to claim 2,
wherein one of said first connection electrode and said second connection electrode is formed under said pixel isolator.

11. A liquid crystal display comprising:
a substrate;
a pixel electrode on said substrate;
a first connection electrode on said substrate and insulated from said pixel electrode;
a second connection electrode on said substrate and insulated from said pixel electrode and said first connection electrode;
a first pixel isolator surrounding said pixel electrode, said first pixel isolator being formed by an insulator;
a first liquid crystal layer on said pixel electrode and surrounded by said first pixel isolator;
a first transparent electrode on said first liquid crystal layer and surrounded by said first pixel isolator, said first transparent electrode being electrically connected to said first connection electrode;
a second pixel isolator formed on said first pixel isolator;
a second liquid crystal layer on said first transparent electrode and surrounded by said second pixel isolator;
a second transparent electrode on said second liquid crystal layer and surrounded by said second pixel isolator, said second transparent electrode being electrically connected to said second connection-electrode;
a third liquid crystal layer on said second transparent electrode;
a common electrode on said third liquid crystal layer; and
a counter substrate on said common electrode.

12. A liquid crystal display according to claim 11, further comprising:
a first conductor connecting between said first connection electrode and said first transparent electrode, said first conductor being provided on said first pixel isolator; and
a second conductor connecting between said second connection electrode and said second transparent electrode, said second conductor being provided on said second pixel isolator.

13. A liquid crystal display according to claim 11, further comprising:
a first conductor connecting between said first connection electrode and said first transparent electrode, said first conductor being provided on said first pixel isolator;
an insulator provided between said first pixel isolator and said second pixel isolator; and
a second conductor connecting between said second connection electrode and said second transparent electrode, said second conductor being provided on said insulator.

14. A liquid crystal display according to claim 11, further comprising an:
insulator formed between said first connection electrode and said second connection electrode.

15. A liquid crystal display comprising:
a substrate;
a pixel electrode on said substrate;
a pixel isolator isolating said pixel electrode on said substrate;
a first connection electrode on said substrate and insulated from said pixel electrode;
a second connection electrode on said substrate and insulated from said pixel electrode and said first connection electrode;
a first liquid crystal layer on said pixel electrode and isolated by said pixel isolator;
a first transparent electrode on said first liquid crystal layer and isolated by said pixel isolator, said first transparent electrode being electrically connected to said first connection electrode;
a second liquid crystal layer on said first transparent electrode and isolated by said pixel isolator;
a second transparent electrode on said second liquid crystal layer and isolated by said pixel isolator, said second transparent electrode being electrically connected to said second connection electrode;
a third liquid crystal layer on said second transparent electrode;
a common electrode on said third liquid crystal layer; and
a counter substrate on said common electrode.

16. A liquid crystal display according to claim 15, further comprising:
a conductor connecting between said first connection electrode and said first transparent electrode or connecting between said second connection electrode and said second transparent electrode, said conductor touching said pixel isolator.

17. A liquid crystal display comprising:
a substrate;
a pixel electrode on said substrate;
a pixel isolating means for isolating pixels from each other;
a first liquid crystal layer on said pixel electrode and isolated by said pixel isolating means;
a first transparent electrode on said first liquid crystal layer and isolated by said pixel isolating means;
a second liquid crystal layer on said first transparent electrode and isolated by said pixel isolating means;
a second transparent electrode on said second liquid crystal layer and isolated by said pixel isolating means;
a third liquid crystal layer on said second transparent electrode;
a common electrode on said third liquid crystal layer; and
a counter substrate on said common electrode.

18. A method for manufacturing a liquid crystal display comprising:
forming a pixel electrode, a first connection electrode and a second connection electrode on a substrate, insulated from each other;
forming a pixel isolator surrounding said pixel electrode;
forming a first liquid crystal layer in said pixel isolator and on said pixel electrode;
forming a first transparent electrode on said first liquid crystal layer, said first transparent electrode being connected to said first connection electrode;
forming a second liquid crystal layer on said first transparent electrode; and forming a second transparent electrode on said second liquid crystal layer, said second transparent electrode being connected to said second connecting electrode.
